(19) United States
(12) Patent Application Publication
(10) Pub. No.: US 2014/0266738 A1
(43) Pub. Date: Sep. 18, 2014

(54) Vehicle Safety System

(71) Applicant: James Wang, Bakersfield, CA (US)

(72) Inventor: James Wang, Bakersfield, CA (US)

(21) Appl. No.: 13/801,361

(22) Filed: Mar. 13, 2013

(51) Int. Cl. B60Q 1/00

(52) U.S. Cl. CPC B60Q 1/00
USPC 340/576

(57) ABSTRACT

A vehicle safety system includes a vehicle having a vehicle cabin; a reminder placard mounted to the vehicle; an air sensor mounted to the vehicle, an alcohol indicator light activated by the air sensor when alcohol is detected in the cabin; a forwardly extending telescopic mirror mounted on an extension arm used for allowing a driver to see around a blind turn at an intersection; and a convex mirror mounted to an exterior portion of the vehicle to allow a user to see downward for ease of parking. The air sensor senses the presence of alcohol in the cabin. The vehicle safety system optionally includes an extension arm formed as a flexible leafspring arm connecting the telescopic mirror to the vehicle.

### FIELD OF THE INVENTION

The present invention is in the field of vehicle safety systems.

### DISCUSSION OF RELATED ART

A vehicle safety system for fleet management has been utilized in many different inventions. Some of these inventions are described in United States Patents. For example, many fleet vehicle management systems use a global positioning system, also called GPS for tracking the position, speed and driving history of the vehicle. Other vehicle fleet management systems include engine computers that monitor fuel usage and exhaust history. Fleet management systems can be configured to remind a driver to renew insurance, renew registration and remind a driver to buckle a safety belt.

A variety of different devices have been created for enhancing safety in vehicle driving. For example, United States publication US20120252350 entitled Vehicle Safety Device For Reducing Driver Distractions provides an automatic shutoff switch for a mobile phone.

### SUMMARY OF THE INVENTION

A vehicle safety system includes a vehicle having a vehicle cabin; a reminder placard mounted to the vehicle; an air sensor mounted to the vehicle, an alcohol indicator light activated by the air sensor when alcohol is detected in the cabin; a forwardly extending telescopic mirror mounted on an extension arm used for allowing a driver to see around a blind turn at an intersection; and a convex mirror mounted to an exterior portion of the vehicle to allow a user to see downward for ease of parking. The air sensor senses the presence of alcohol in the cabin. The vehicle safety system optionally includes an extension arm formed as a flexible leafspring arm connecting the telescopic mirror to the vehicle.

The vehicle safety system also optionally includes a convex mirror formed as a dome mirror having a substrate layer adhering to an external surface of the vehicle. The alcohol indicator light can be mounted to a license plate frame that is mounted to of a rear portion of the vehicle.

The motor can be mechanically connected to the forwardly extending telescopic mirror to provide an extension and retraction of the telescopic mirror. An extension arm joint can connect between the extension arm and the forwardly extending telescopic mirror. The extension arm joint is preferably a ball joint. A processor can receive signals from the air sensor to activate the alcohol indicator light. A reminder indicator can be mounted to the reminder placard for indicating a vehicle safety state. The reminder indicator can be a light for drawing attention to its associated reminder message.

### BRIEF DESCRIPTION OF THE DRAWINGS

FIG. 1 is a diagram of the present invention.

FIG. 2 is a diagram of the extendable mirror assembly.

FIG. 3 is a diagram of the extendable mirror arm.

FIG. 4 is a diagram of the external wide view mirror.

FIG. 5 is a diagram of the reminder placard.

The following callout list of elements can be a useful guide in referencing the elements of the drawings.
11 Vehicle Windshield
12 Vehicle Cabin
13 Processor
14 Alcohol Air Sensor
15 Vehicle Exterior
21 License Plate Light
22 License Plate Frame
31 Extension Arm
32 Extension Arm Mirror
33 Extension Arm Socket
34 Extension Arm Electrical Motor
35 Extension Arm Socket Opening
36 Extension Arm Joint
37 Extension Arm Control
41 Reminder Placard
43 First Reminder Indicator
44 Second Reminder Indicator
45 Third Reminder Indicator
51 Wide View Mirror
52 Wide View Mirror Substrate

### DETAILED DESCRIPTION OF THE PREFERRED EMBODIMENT

A vehicle safety system includes a vehicle frame having a vehicle cabin 12 and vehicle exterior surface 15. The vehicle cabin is enclosed by a vehicle windshield 11. The user of the vehicle is the driver that operates the vehicle from the vehicle cabin.

Four major components are mounted to the vehicle. The first component is a warning placard 41 that can include a message not to leave valuables in the car. The warning placard may have a first reminder indicator 43 indicating a state of the warning. The warning placard may have a second reminder indicator 44 and a third reminder indicator 45. Each of the warning indicators may provide information for the user to state a condition. The warning indicators can be formed as LED lights that backlight or light next to a warning. For example, the first warning may be a warning not to leave valuables in the car. The warning indicator flashes next to the warning text to remind the user not to leave valuables in the car. A second warning indicator can be the presence of an open alcoholic beverage container in a car. The second warning indicator can be a different color LED light mounted normal to a surface of the warning placard. The second warning indicator activates when an open beverage container is detected in the vehicle. The third warning indicator can be a battery drain indicator that senses the presence of battery drain on the vehicle and flashes when battery energy is being consumed when the vehicle is empty. Each of the three warning indicators can be an LED light mounted perpendicular to the surface of the warning placard such as to be able to be seen by a user upon entering the vehicle. The warning placard can be mounted to a side of the vehicle such as a vehicle door with the required circuit wiring passing through the vehicle door or having a wireless connection to the processor unit 13.

The second component of the vehicle safety system is a tail light having a flashing light that is a license plate light 21 that is mounted to the license plate frame 22. The license plate light 21 flashes if an alcohol sensor 14 which is an air sensor within the vehicle detects the presence of alcohol such as alcohol from an open beverage container. The flashing of the light will alert a viewer such as a fleet manager or security control standing external to the vehicle. The flashing light is activated by the processor unit and can be activated with or without wire connection. The alcohol sensor 14 and the processor unit 13 can be mounted to the vehicle exterior 15 or to the inside of the vehicle such as on a dashboard. The alcohol sensor 14 and the processor unit 13 can be mounted within a single housing such as a plastic clamshell housing having an upper shell and a bottom shell enclosing a printed circuit board within.

The third component of the vehicle safety system is a telescopic mirror. The telescopic mirror is mounted on an extension arm 31. The extension arm mirror 32 is mounted to the tip of the extension arm 31. The telescopic mayor has a left telescopic mirror portion and a right telescopic mirror portion. The telescopic mirror has an extended position and a retracted position. The telescopic mirror extends when a vehicle reaches an intersection so that the vehicle can safely park or the user can safely see around a blind turn. The extension arm can be powered by an electric motor that extends the extension arm when the vehicle comes to a blind turn. The mirror is mounted to the extension arm at an extension arm joint which can be a ball socket joint or a comparable motion joint. The user needs to adjust the mirror angled so that when extended, a user can see around blind turns. An assistant may assist the user in adjusting the mirror angle, or the user can adjust the mirror by viewing the mirror from the direction of a driver.

As seen in FIG. 3, the extension arm extends and retracts telescopically between a first position to a second position. The extension arm extends telescopically from a retracted position to an extended position and can be retracted from an extended position to a retracted position. The extension arm retracts within the extension arm socket 33. The extension arm mirror 32 can also be retracted into the extension arm socket 33. The extension arm socket 33 can be formed as a sleeve, cylinder or tube having a hollow for housing the retracted extension arm. The extension arm can have an electrical motor 34 to allow a user to extend and retract the extension arm without need for manual direct connection. The electrical motor can provide linear motion if a linear motor is provided such that an inside end of the extension arm inside the extension arm socket is connected to the linear motor. A wide variety of different actuation mechanisms can provide actuation of the retraction of the extension arm. The extension arm joint can also be extended and retracted within the extension arm socket 33 without losing its angular setting.

When a user needs to use the extension arm, the user can activate the extension arm at a control 37 within the cabin of the vehicle. The user can control the extension arm with a switch or button for example. If the control is a push button, the user can press the button to retract the extension arm and press another button to extend the extension arm.

The fourth component of the vehicle safety system is an external convex mirror that is secured to and exterior surface of the vehicle to allow it a driver to see in blind spots during parking or tight maneuvers. The convex mirror is a wide view mirror 51 that can be domed shaped and mounted to the vehicle by a wide view mirror substrate 52. A substrate such as a double-sided sticky tape can be used for securing the dome shaped mirror to an external service of the vehicle. A user uses the dome shaped mirror by looking outside of the vehicle to see the dome of the mirror. The convex curvature of the mirror is preferably aerodynamic and does not necessarily need to be parabolic or circular in nature.

The present invention is designed for use by fleet of vehicles such as trucks and delivery cars. The safety components are synergistic in nature. The alcohol air sensor and warning flashing lights detect open alcohol beverage containers in the vehicle during vehicle operation. The warning message may also have other public safety messages that can be updated such as to obey the speed limit. The telescopic mirrors are mounted on flexible arms that can be flexed left to right or up down. The flexible arms can be coil or leaf springs. The convex mirror is preferably placed at an exterior forward portion of the vehicle so that a user can see downward for improved parking convenience and for improved parking alignment.

The usage of the present invention is as follows. The vehicle is typically stored in a fleet yard with other vehicles. To decrease potential liability of fleet management, having an air sensor detects the presence of open alcohol containers can be useful in reducing alcoholic beverage related liability.

1. A vehicle safety system comprising:
a. a vehicle having a vehicle cabin;
b. a reminder placard mounted to the vehicle;
c. an air sensor mounted to the vehicle, wherein the air sensor senses the presence of alcohol in the cabin;
d. an alcohol indicator light activated by the air sensor when alcohol is detected in the cabin;
e. a forwardly extending telescopic mirror mounted on an extension arm used for allowing a driver to see around a blind turn at an intersection; and
f. a convex mirror mounted to an exterior portion of the vehicle to allow a user to see downward for ease of parking.

2. The vehicle safety system of claim 1, wherein the extension arm is formed as a flexible leafspring arm connecting the telescopic mirror to the vehicle.

3. The vehicle safety system of claim 1, wherein the convex mirror is formed as a dome mirror having a substrate layer adhering to an external surface of the vehicle.

4. The vehicle safety system of claim 1, wherein the alcohol indicator light is mounted to a license plate frame that is mounted to of a rear portion of the vehicle.

5. The vehicle safety system of claim 1, further comprising a motor mechanically connected to the forwardly extending telescopic mirror to provide an extension and retraction of the telescopic mirror.

6. The vehicle safety system of claim 1, further comprising an extension arm joint connecting between the extension arm and the forwardly extending telescopic mirror, wherein the extension arm joint is a ball joint.

7. The vehicle safety system of claim 1, further comprising a processor that receives signals from the air sensor and activates the alcohol indicator light.

8. The vehicle safety system of claim 1, further comprising a reminder indicator mounted to the reminder placard for indicating a vehicle safety state, wherein the reminder indicator is a light for drawing attention to its associated reminder message.

9. The vehicle safety system of claim 1, wherein the extension arm is formed as a flexible leafspring arm connecting the telescopic mirror to the vehicle.

10. The vehicle safety system of claim 1, wherein the convex mirror is formed as a dome mirror having a substrate layer adhering to an external surface of the vehicle.

11. The vehicle safety system of claim 1, wherein the alcohol indicator light is mounted to a license plate frame that is mounted to of a rear portion of the vehicle.

12. The vehicle safety system of claim 1, further comprising a motor mechanically connected to the forwardly extending telescopic mirror to provide an extension and retraction of the telescopic mirror.

13. The vehicle safety system of claim 1, further comprising an extension arm joint connecting between the extension arm and the forwardly extending telescopic mirror, wherein the extension arm joint is a ball joint.

14. The vehicle safety system of claim 1, further comprising a processor that receives signals from the air sensor and activates the alcohol indicator light.
